(19) United States
(12) Patent Application Publication
(10) Pub. No.: US 2009/0070321 A1
(43) Pub. Date: Mar. 12, 2009

(54) USER SEARCH INTERFACE

(76) Inventors: Alexander Apartsin, Rehovot (IL); Vladimir Tchemerisov, Kiryat Ono (IL); Vitaly Cooperman, Rehovot (IL)

Correspondence Address: YORAM TSIVION, P.O. BOX 1307, PARDES HANNA, 37111, IL

(21) Appl. No.: 12/194,550

(22) Filed: Aug. 20, 2008

Related U.S. Application Data
(60) Provisional application No. 60/971,272, filed on Sep. 11, 2007.

(51) Int. Cl. G06F 17/30

(52) U.S. Cl. 707/5; 707/E17.016; 707/E17.141; 707/E17.03

(57) ABSTRACT

A search mechanism for users of search engines includes a back-end information retrieval system which accepts terms and weights thereof as input set from a front-end and processes said set. A front-end system interacting with said back-end information retrieval system. A database that is searchable by the backend information retrieval system. The search mechanism further includes a visual search interface module (VSI) implemented through the front-end system, where the graphic user interface module is used to change suggested-terms and refine query of multimedia search.

The applicant claims the benefits of US provisional application 6105925, entitled “A user interface and method for textual or image search and retrieval systems operated through keyboard and mouse, Mobile phone keypad, TV remote or games console controller” filed on 8 Jun. 2008 and US provisional application 60971272, entitled “A user interface for weighted terms query formulation, refinement and term suggestion for information retrieve systems” filed on 11 Sep. 2007.

### FIELD OF THE INVENTION

The present invention relates to a visual search user interface for information retrieve systems. More specifically, the present invention relates to an intuitive user visual interface for text, content-based image search and other types of multimedia search.

### BACKGROUND OF THE INVENTION

Search engines are essentially software programs which search databases, collect and display information related to search terms specified by a user. A typical search engine allows a user to search for content, through an interface where the user typically enters a search term or a query to be searched in a textual user interface. The search engine then searches for the search term in databases on the computer system or the network using different algorithms. The search engine then presents a list of search results to the user, which is often with respect to some measure of relevance of the results.

In information retrieve/search systems, a user is provided with specific query language and a user interface for query formulation. Weighting of query terms (keywords) by associating a numerical value with a query term gives much more power to a query language through explicitly indicating a degree of relevance (positive weight) and irrelevance (negative weight) of a term in a return document. Moreover, users frequently require assistance/cues in selecting right terms and refining the query and term's weight to achieve desired set and ordering of retuned results. However, additional input required from users in form of weights makes it less friendly for average user to use weighted term queries.

Content-based image retrieval (CBIR), also known as query by image content (QBIC) and content-based visual information retrieval (CBVIR) is a method of searching for digital images in large databases. “Content-based” means that the search will analyze the actual contents of the image. The term ‘content’ in this context might refer to colors, shapes, textures, or any other information that can be derived from the image itself. Without the ability to examine image content, searches rely on metadata such as captions or keywords. A reference that reviews prior art articles on content-based multimedia information retrieval including content-based image retrieval is given next and its contents are incorporated herein by the reference. Content-based Multimedia Information Retrieval: State of the Art and Challenges, Michael Lew, et al., ACM Transactions on Multimedia Computing, Communications, and Applications, pp. 1-19, 2006.

The sections below describe common methods for extracting content from images so that they can be easily compared. Retrieving images based on color similarity is achieved by computing a color histogram for each image that identifies the proportion of pixels within an image holding specific values (that humans express as colors). Retrieving images based on shape is another method for extracting content. Shape in this context does not refer to the shape of an image but to the shape of a particular region that is being sought out. Shapes will often be determined first applying segmentation or edge detection to an image. In some cases accurate shape detection will require human intervention because methods like segmentation are very difficult to completely automate. Segmentation refers to the process of partitioning a digital image into multiple regions (sets of pixels). The goal of segmentation is to simplify and/or change the representation of an image into something that is more meaningful and easier to analyze. Image segmentation is typically used to locate objects and boundaries (lines, curves, etc.) in images.

A schematic block diagram of a typical prior art content-based image retrieval system is described in FIG. 1 to which reference is now made. Content-based image retrieval, uses the visual contents of an image such as color, shape and texture to represent and index the image. In typical content-based image retrieval systems, visual content of the images in database 1 are extracted as a visual content of an image 2 and described by multi-dimensional features vectors. The feature vectors of the images in the database form feature database 3. To retrieve images, users provide query 4 (e.g. a retrieve with example images or sketched figures). The system then changes visual content 5 of these examples/queries into its internal representation of feature vector 6. The similarities/distances between the feature vectors of the query example or sketch and those of the images in the database are then calculated 7 and retrieval is performed with the aid of an indexing scheme 9. Indexing scheme 9 provides an efficient way to search for the image database. Some prior art retrieval systems have incorporated user's relevance feedback 10 to modify the retrieval process in order to generate perceptually and semantically more meaningful retrieval results 11.

Various attempts have been made to increase the relevancy of the search results for the user and make the search interface more user-friendly. A method and a system for re-arranging the search results based on user-defined attributes for various search objects is disclosed in US 2008/0104040. In one or more embodiments, the system and method for re-arranging search results according to user stylized search terms. The user can stylized the search terms in various ways so as to give a search term priority over another.

There is a need for a visual search interface for conducting a media search with different priorities assigned by the user to different search terms for having more relevant search results. There is also a need for an intuitive visual interface for refining search queries and for providing additional information with regard to user need.

### BRIEF DESCRIPTION OF THE DRAWINGS

FIG. 1 is a schematic block diagram of a typical prior art content-based image retrieval system.

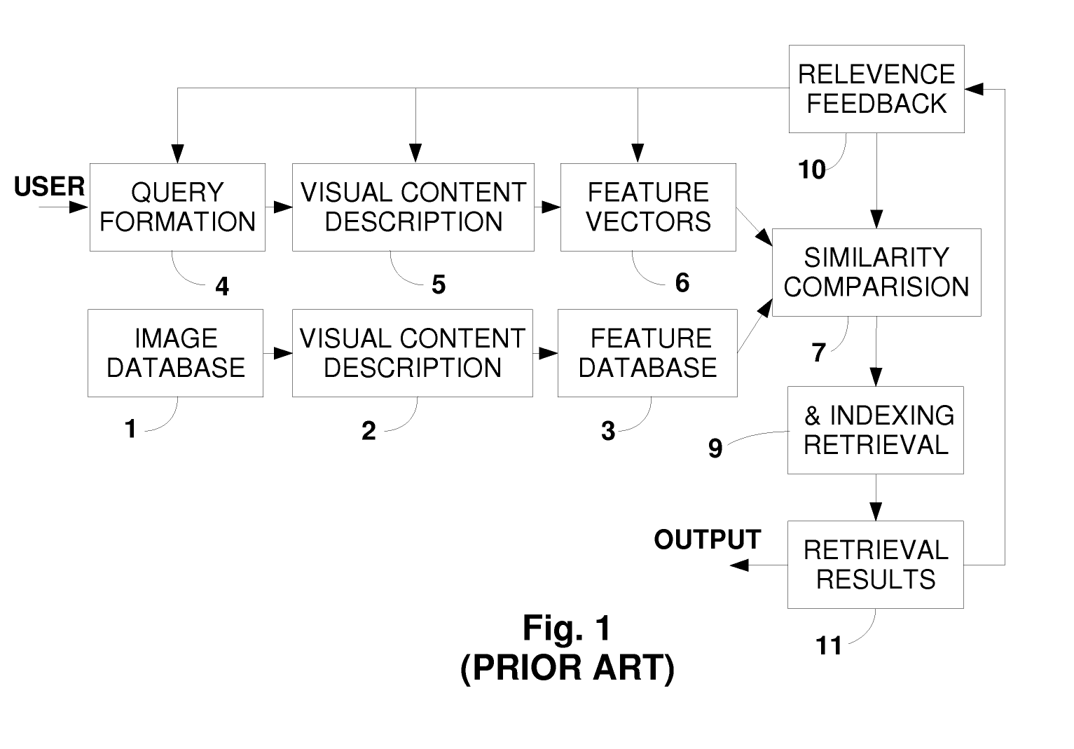

FIG. 2 is a schematic block diagram of the system provided by the present invention showing interactions between the user and the major blocks of a system implementing the invention.

FIG. 3 is a flow chart describing a process in accordance with the present invention for increasing the relevancy of search results and providing additional information with regard to user need;

FIG. 4 is a schematic description of a visual search interface for conducting a text search in accordance with the present invention;

FIG. 5 is a schematic description of an exemplary visual search interface for a user to conduct a content-based image search in accordance with the present invention;

FIG. 6 is a schematic description of an exemplary user interaction scheme with the visual search interface for conducting an image search in accordance with the present invention;

### DETAILED DESCRIPTION OF THE PRESENT INVENTION

The present invention features a searching mechanism which includes a visual search interface for search engines that can be applied with various viewing platforms such as personal computers (PC), personal digital assistants (PDA), cellular phones and TV Consoles. Several input devices such as remote control (e.g. TV remote control, game console remote control), PC-mouse, keypad and touch screen can be used in association with the visual search interface for presenting and refining query by the user. The framework in which the present invention is implemented includes a back-end information retrieval system which accepts weighted terms input set and process the set in a way similar to “vector space model” method which is an algebraic model for representing text documents and any objects, in general as vectors of identifiers, such as, for example, index terms. The “vector space model” is used in information filtering, information retrieval, indexing and relevancy rankings. The vector space model was first presented by G. Salton, A. Wong, and C. S. Yang in “A VECTOR SPACE MODEL FOR AUTOMATIC INDEXING” in Communications of the ACM, vol. 18, nr. 11, pages 613-620, November 1975.

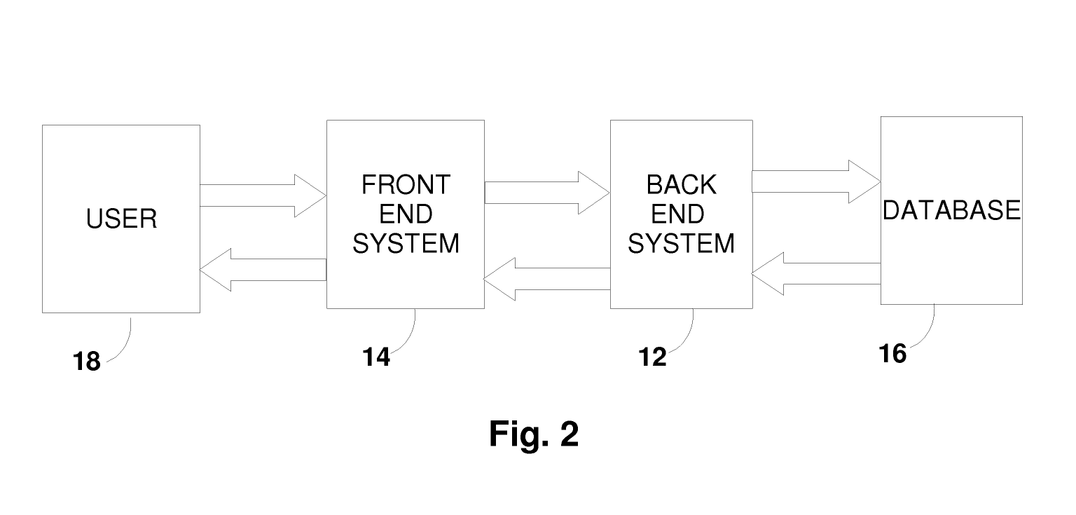

As can be seen in FIG. 2 to which reference is now made, a searching mechanism includes back-end system 12 which interacts with front-end system 14. Back-end system 12 also interacts with an available database 16. User 18 interacts with the entire system through a novel graphic approach implemented by front end system 14. The user visual search interface (VSI) implemented through front-end system is used for exerting influence over the searched database of different priorities as assigned by the user. The priorities are assigned to different search terms to increase the relevancy of the search results and for providing additional information with regard to user needs. The various interactions between modules of a system incorporating an embodiment of the invention are now further explained. Back-end system (BES) returns a resulting set of data elements such as documents and a list of suggested terms with their associate weights (e.g. according to term frequency within the resulting set), in response to a request of the user by the front-end system (FES). At the front-end, the visual search interface available to the user, displays a “term-cloud”. The “term-cloud” combines suggested and query terms and allows the user to change visual appearance of a term through the VSI. As a result, new query is formulated which corresponds to visual appearance of a “term-cloud” as shaped by the user. A “term-cloud” is a stylized way of visually representing occurrences of words, images, or other multimedia used to describe tags. The most popular topics are normally highlighted in a larger, bolder font. A tag is a search term that can be attached to audio files, video files, web pages, photos, blog posts, or practically anything else on the web. Tags help other users to find and organize information.

The VSI in accordance with the present invention can be used as part of any information retrieval system such as web and e-commerce search engine, desktop search, enterprise data warehouse search application and etc. The VSI is associated with many content types such as images, text and structured database. The VSI of the present invention uses visual representation of terms to represent query, returned summary results respectively and related terms that might be used for query refinement, i.e. suggestion terms. In accordance with the present invention a VSI user can refine or formulate a query by changing visual appearance of terms or by reordering terms or by merging/splitting visual representation of terms. The visual representation of terms is not limited to words, phrases, image elements, video elements, product/object features or attributes and query clauses (e.g. OR query). The visual appearance of the terms can be shown with font size, image size color textual effects such as italic, bold and strike through. Special characters displayed along terms such as, “*”, “?”, “˜”, “-” and etc. icons displayed alongside to term. Icons representing query language operators such as OR, and etc. frames and layers over image regions or textual terms and thickness of frames, underlines or other visual effects to indicate term importance/relevancy.

The visual appearance of terms is manipulatable by means of implementing a selecting and or pointing devices such as menu selection via PC mouse or keyboard, interaction with PC or mobile device as by means of a touch screen, interaction with remote control buttons, e.g. T.V. remote control, interaction with handheld pointing device, possibly with movement detection mechanism, e.g. “Nintendo Wii remote” and mobile device keypad, e.g. phone keypad.

The Wii Remote, sometimes nicknamed “Wiimote”, is the primary controller for Nintendo's Wii console. A main feature of the Wii Remote is its motion sensing capability, which allows the user to interact with and manipulate items on screen via movement and pointing of the controller. The menu of the VSI includes a suggested modification of current visual appearance and consequently weight and role of a term within the query. In some implementations, the VSI menu further includes advertising/sponsored terms related to a suggested or query term or to a part or whole of “term-cloud”. The VSI menu may also include links (e.g. sponsored links), text or images. Translation or other information regarding current term, e.g. related encyclopedia article. Spelling suggestions and related words or expanded/refined search query clauses including terms in another language. The menu of the VSI may include further semantically related terms and metadata tags attached to content by the user or other users. Inter alia, the VSI menu is used in the process of query refinement or as supplementary information.

The VSI allows the building of complex terms, query and clauses by dragging-and-dropping, for example changing order of terms in cloud/query. Creating exact phrase or OR clauses by drag-and-drop term on a term. Allowing editing new terms (e.g. insert additional words in exact phrase terms). Allow splitting of complex terms into components by selecting menu/icons present along the term.

Suggestion of terms might not limited to, Importance of terms in the results, e.g. frequency or other measure of importance, frequency of terms in similar queries submitted by other users, descriptive power of terms (terms that have most effect on a search result). Similarity of terms (e.g. image regions) to query terms and predefined set of features are also examples of Importance or relevance of terms in the list results.

In accordance with some aspects of the present invention visual representation of user query can be saved for future use by the same or other users. Moreover, a user can name and use a “term-cloud” as single term in other “term-clouds”.

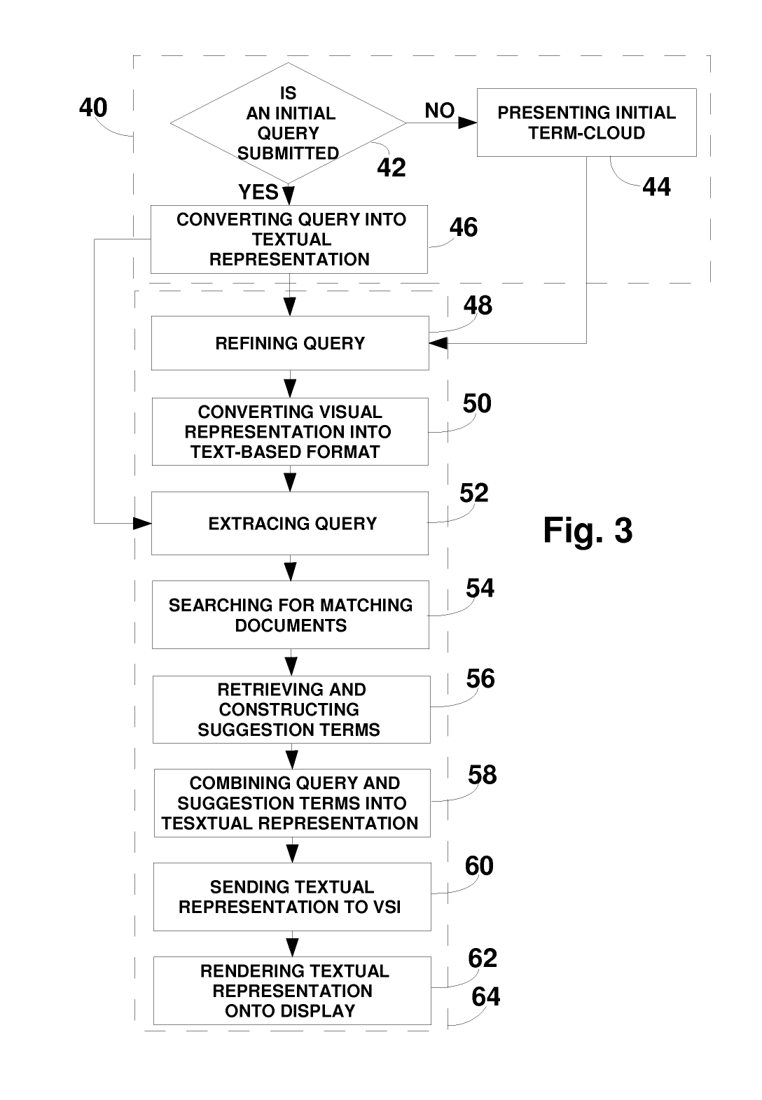

A flowchart describing the process for refining and submitting query of the search results in accordance with the present invention is shown in FIG. 3 to which reference is now made. In order to make an initial query submission 40, an initial query is submitted at step 42. If an initial query is not submitted at step 42 then the user is presented with initial cloud-term 44, e.g. last recently used search terms. If initial query is to be submitted at step 42 then the user enters initial text query at step 44 and VSI converts query into textual representation of a term-cloud and send it to the backend system at step 46. User refines query using VSI and an input device (e.g. mouse, keypad, remote control, touch screen) at step 48. VSI converts a visual representation of whole or portion of term-cloud into text-based format and sends it to the backend system at step 50. The backend system extracts a query from textual or image term-cloud representation and optionally record user data for future use at step 52. The backend system searches for matched documents in databases according to received query and optionally using some additional context at step 54. The backend system retrieves and constructs suggested-terms along with spelling, translation, contextual advertisement and reference links at step 56. Set of Related terms to one or more query (e.g. most prominent or popular terms) referred to hereinafter as suggestion-terms.

The backend combines query and suggested-terms back into textual representation of term-cloud at step 58. Backend system ends textual representation of term-cloud along with retrieved results to VSI at step 60. VSI renders textual (or image) representation of a term-cloud onto display along with retrieved results at step 62. Steps 48, 50, 52, 56, 58, 60 and 62 are part of the query refinement procedure 64.

It should be noted that some steps of the above described process can be combined, executed repeatedly, omitted and/or rearranged.

While a “term-cloud” is a well known concept, this invention includes new functionality to the “term-cloud” concept, by allowing a user to manipulate/interact with a “term-cloud” in order to reshape it, to accommodate it according to the user desired form, thus, making a “term-cloud” both an input and an output tool

### EXAMPLE 1

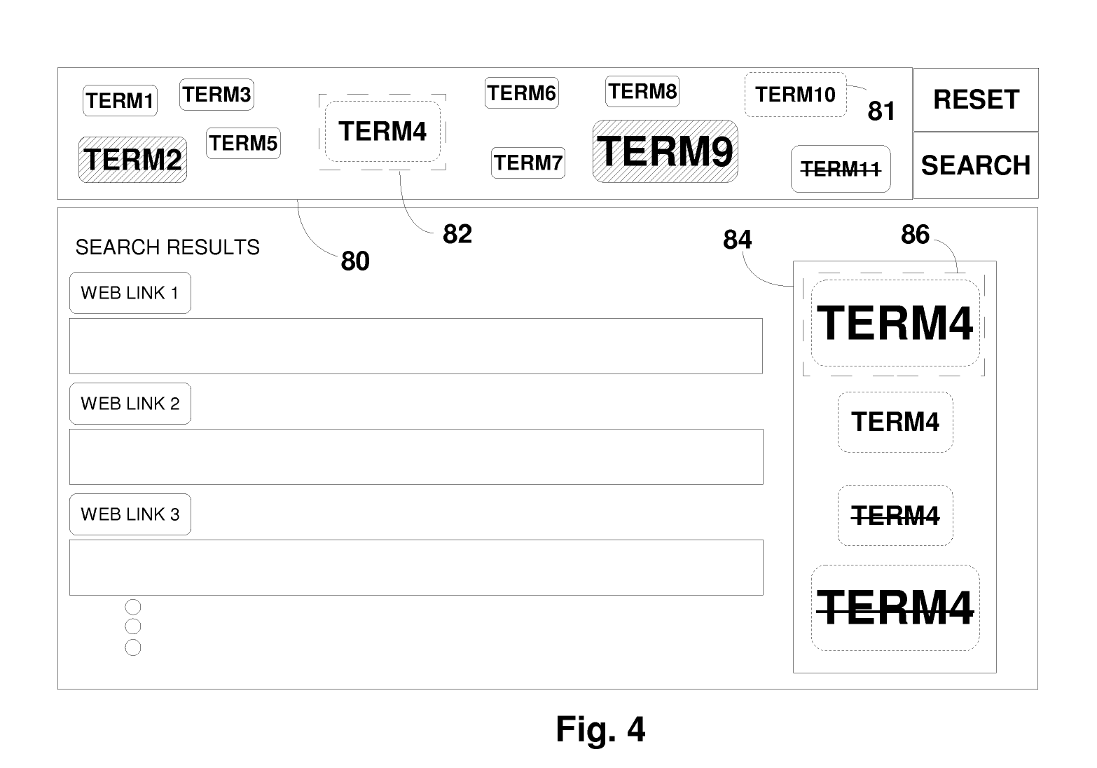

A schematic description of a visual search interface for conducting a text search in accordance with the present invention is described in FIG. 4 to which reference is now made. The VSI interactive “term-cloud” 80 consists of suggested and query terms (e.g. keywords) displayed for example as a text with different visual cues (font size, color and font effects, e.g. strikethrough). In the example, the suggested terms are enclosed with a continuous line boxes and query terms (such as query term 81) are enclosed with a dashed line box. In accordance with some embodiments of the present invention the user can change a suggested term to query term and vice versa, in addition the user can change the correspondence weights of the terms.

A user is provided with an input device, not shown such as remote control (e.g. TV remote control, game console remote control), PC-mouse, keypad and touch screen which allows changing visual attributes of a term by shaping “term-cloud” to the desired form. The user navigates between terms by the input device. The input device may allow for example to decrease or increase a size of chosen term, or allow changing the color of a chosen term. Therefore, correspondence between weighted query and returned order set of search results is established. Within a “term-cloud”, a single search term is represented by set of visual attributes according to a term function and a weight (e.g. terms which are part of a user query or suggested terms, positive or negative term weights and term frequency in resulting set). The user can change the attributes of term 82 by selecting a different weight to be replaced instead of the attributes of term 82 from a set of possible options 84. In this example term attribute 82 is replaced by the user with term attribute 86 because the user decided that term attribute 86 is more relevant to his term search.

In accordance with some embodiments of the present invention a user intuitive visual search interface is provided for conducting content based image search with different priorities assigned by the user to different search terms for having more relevant search results. Furthermore the visual search interface is user-friendly for refining search queries and for providing additional information with regard to user need. Examples of such visual interface are described next.

### EXAMPLE 2

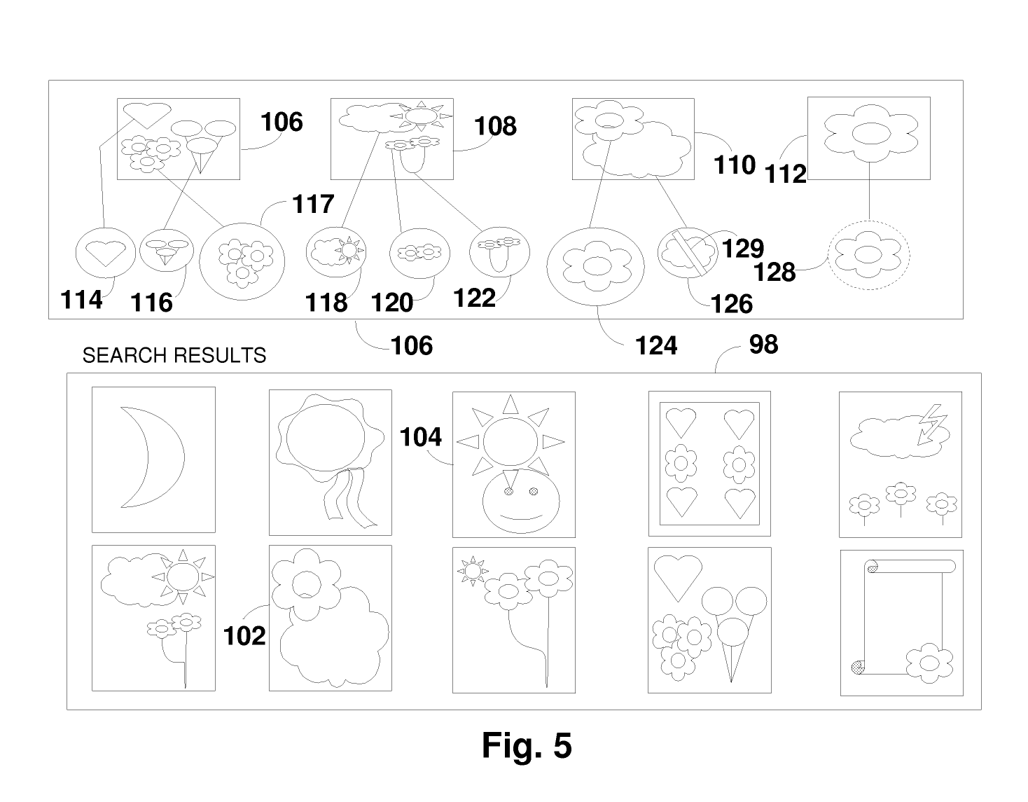

In this example a visual search interface for conducting content-based image search in accordance with the present invention is described with reference to FIG. 5.

Image search (or image search engine) is a type of search engine specialised on finding pictures, images, animations etc. Like the text search, image search is an information retrieval system designed to help find information typically on the Internet, using keywords or search phrases and to receive set of thumbnail images 98, sorted by relevancy. In this example the user uses the keyword query term “flower” and receives set of thumbnail images 98 such as image of flowers with cloud 102, image with smiley face and a sun 104 and etc.

The image retrieval system in association with visual user interface of the invention displays summary of retrieved results 106,108,110 and 112 with indications of relevancy of particular search image segments 114,116,117,118,120,122,124,126 and 128. The visual user interface displays an intuitive interface for providing search image segments and their importance with user's information needs. For example, image segment 124 has more relevance than image segment 126. Both image segments 124 and 126 have positive weight of relevance. Image segment 126 for example has negative weight of irrelevance degree indicated by the size of the region and rectangular 129 that crosses image region 126 diagonally. The size of the image region is an example of a visual cues indicating frequency of image regions within the result set or other suggested image regions (e.g. frequently used images).

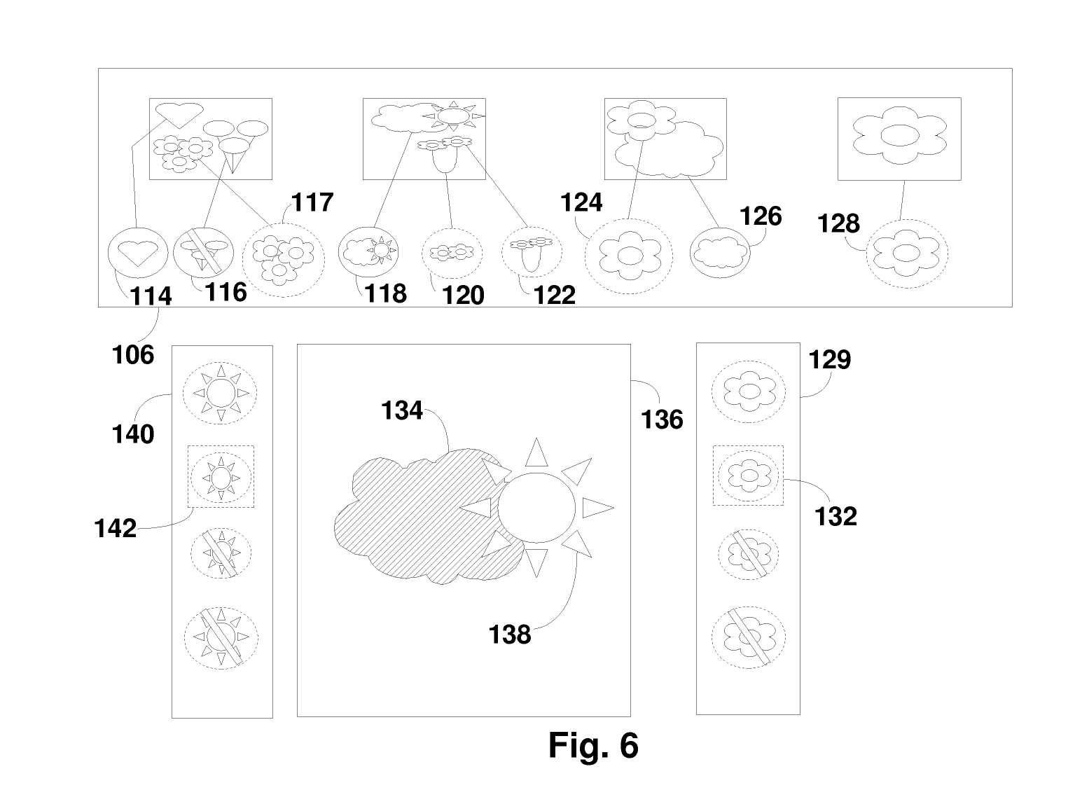

As shown in the example, a segmented region of suggested terms (e.g. segmented regions 114,116) are encircled with a continuous line while a segmented region of query term (e.g. segmented region 128) is encircled with a dashed line. In accordance with some embodiments of the present invention the user can change a suggested term (or segmented region of suggested terms) to query term and vice versa, in addition the user can change the correspondence weights of the terms (or segmented region of suggested terms). For example, as shown in FIG. 5, suggested segmented terms 117, 120, 122,124,128 are changed by the user as shown in FIG. 6 as query segmented terms.

### EXAMPLE 3

An example of user interaction with the visual search interface for conducting content-based image search in accordance with the present invention is described in conjunction with FIG. 6 to which reference is now made. The user can interact with the VSI through keyboard, mouse, mobile phone keypad, TV remote control, game console controls to change visual appearance of the terms of image regions to indicate degree of relevancy or irrelevancy to the terms user seeks. After the user type in query or obtain initial suggested terms. The user evaluate image regions based on their visual appearance (size, color, visual effects) indicating their importance/distribution within the result. The user can interact with related set of images 106 using mouse, keyboard, mobile phone keypad, TV remote control or game console remote control to change their visual appearance and, thus, indicating desired relevance or irrelevance to user information needs. The user can change the relevance (weight) of image region 124 for example by selecting an image region with a different weight to be replaced instead of the current image region from a set of possible options 129. In this example image region 124 is replaced with image region 130 which the user thinks that it is less relevant to his image search.

In this example the degree of relevance (or irrelevance) of an image region to the user needs is indicated by the size of the image region and by the image region crossed diagonally by a rectangular shape to indicate negative weight or degree of irrelevancy. The degree of relevance of an image region that a user chooses is designated by a dashed square 132 that surrounds the chosen image region 124 to be replaced. In some embodiments of the present invention the user can refined a segmentation results to higher or lower hierarchy level, for example, the user can separate between objects within segmentation (image region), ignore one or more of the objects and choose a different degree of characterization or relevancy to the objects which are not ignored. For example, the user ignores cloud 134 within image region 136. After the user ignores cloud 134 only sun image is left and the user can now choose relevance degree of the sun from a set of options 140 as indicated by dashed square 142.

Contextual advertising is targeted to the specific individual who is visiting the Web site. A contextual advertising system scans the text of a Web site for keywords and returns ads to the Web page based on what the user is viewing, either through ads placed on the page or pop-up ads. Contextual advertising also is used by search engines to display ads on their search results pages based on what word(s) the users has searched for. In one aspect of the present invention the VSI is used as a tool for defining target and budget allocation for contextual advertisement. For example, a user that wants to advertise on the web can choose key words by using the VSI of the invention.

In another aspect of the present invention the VSI is used as a tool for creating metadata for specific content. For example, if a specific term is changed by many users then this metadata is stored in a database and can be used further foe example in the segmentation and feature extraction processes.

1. A search mechanism for users of search engines comprising:
a back-end system which accepts terms and weights as input sets from a front-end and processes said set;
a front-end system interactable with said back-end system;
a database searchable by said back-end information retrieval system;
a visual search interface (VSI) implemented through said front-end system, wherein said visual search interface is used to change suggested-terms and refine query of multimedia search.

2. A search mechanism for search engines as in claim 1 wherein said visual search interface is applied to any viewing platforms selected from a group consisting of computer (PC), personal digital assistant (PDA), cellular phone and TV Console.

3. A search mechanism for search engines as in claim 2 wherein the input devices of said viewing platform are selected from a group consisting of: PC-mouse, keyboard, electronic pencil, mobile keypad, TV remote control and game console remote control and any combination thereof.

4. A search mechanism for search engines as in claim 1 wherein the terms of said multimedia search are selected from a group consisting of text, videos, images and any combination thereof.

5. A search mechanism for search engines as in claim 3, wherein a user interface module comprises a “term-cloud” combining suggested and query terms, allowing said user to manipulate the visual appearance of a term through said graphic user interface module by implementing a selecting and/or a pointing device, for formulating a new query which corresponds to a visual appearance of a “term-cloud” as shaped by said user.

6. A search mechanism for search engines as in claim 1, wherein said user visual search interface refines and formulates a query by changing visual appearance of terms, reordering terms and by merging/splitting visual representation of terms.

7. A search mechanism for search engines as in claim 1, wherein the relevance of image region is changeable through said VSI by selecting an image segment with a different weight to replace a current image segment from a set of possible options.

8. A search mechanism for search engines as in claim 1, wherein a user of the VSI can separate through said VSI between segmented regions within an image region, ignore one or more segmented regions and choose a different weight to one or more segmented regions which are not ignored.

9. A search mechanism for search engines as in claim 5, wherein said visual representation of user query is saved for future use by the same or other users and wherein said user uses said saved “term-cloud” as single term in other “term-cloud”.

10. A search mechanism for search engines as in claim 1, wherein said mechanism is used as a tool for defining target and budget allocation for contextual advertisement.

11. A search mechanism for search engines as in claim 1, wherein said system is used for creating metadata for a specific content.

12. A search mechanism for search engines as in claim 1, wherein said user is able to change a suggested term or a segmented region of such a suggested term into a query term and change the weights of said query terms or said segmented region of suggested terms.

13. A method for selecting and refining terms and their weight of a query of a search engine through by using a visual user interface, comprising the steps:
presenting to the user an initial term-cloud in a front-end system;
refining query with visual search interface (VSI) and an input device associated with said VSI;
converting visual of whole term-cloud or part of said term-cloud to text-based format and sending said term-cloud to a back-end system;
extracting a query from a textual cloud representation and optionally recording user data for future use;
searching for matching documents in a databases according to said query;
retrieving and constructing terms selected from a group comprising suggestion terms, spelling terms, translation terms, contextual advertisement terms and reference links terms;
combining query and suggestion terms back into textual representation of a term-cloud;
sending textual representation of a term-cloud in to VSI, and
rendering textual representation of a term-cloud onto a display accommodating said retrieved results.
